(19) United States
(12) Patent Application Publication
(10) Pub. No.: US 2021/0197993 A1
(43) Pub. Date: Jul. 1, 2021

(54) PACKAGING MACHINE

(71) Applicant: DELTAPAK S.r.l., Reggio Nell"Emilia (IT)

(72) Inventor: Carlo Alberto ARCHILLI, Podenzano (IT)

(73) Assignee: DELTAPAK S.r.l., Reggio Nell"Emilia (IT)

(21) Appl. No.: 17/273,579

(22) PCT Filed: Sep. 4, 2019
(86) PCT No.: PCT/IB2019/057447

§ 371 Date: Mar. 4, 2021

(30) Foreign Application Priority Data
Sep. 4, 2018 (IT) 102018000008351

(51) Int. Cl. B65C 1/02; B65C 9/28; B65C 9/36

(52) U.S. Cl. CPC B65C 1/021; B65C 9/36; B65C 9/28

(57) ABSTRACT

A packaging machine for packaging products with extendible film is provided with a labelling unit for automatically applying a label to a packaged product and comprises a labeller and a label applying device, in which the label applying device comprises a first arm that is substantially horizontal and parallel to a first side of said labeller on which an outlet port is positioned of said label by said labeller, an applicator pad fitted to said first arm, a second arm that is substantially horizontal and parallel to a second side of said labeller to support said first arm, said first arm and said second arm being vertically movable to remove said label from said outlet port and apply the label to said product.

The invention relates to a packaging machine for packaging products with extendible film, provided with a side gripper unit for gripping the extendible film from the side.

Automatic packaging machines for packaging food products are known, in particular fresh food such as meat, fish, fruit and vegetables or gourmet products, for example inside supermarkets. Such packaging machines receive an incoming product that is arranged and placed on a tray by an operator, the tray being made of cardboard or expanded polystyrene or another similar material, and wrap the product with extendible transparent film, so that the product can be displayed on a shelf or in a refrigerator display window.

Document EP0619227A1 discloses a packaging machine for packaging fresh products.

The need is increasingly felt today to apply a label to the packaged product containing the information on the product and the packaging thereof.

With known machines, the operator removes a packaged product from a packaging machine and arranges the packaged product in an apposite labeller, in which the information on the product is entered by the operator each time.

One object of the invention is to make constructional improvements to a product packaging machine with an extendible film of known type, for example of the type disclosed in EP0619227A1.

A further object of the invention is to provide a packaging machine with an extendible film that is able to supply a package already provided with a label.

These and other objects are achieved by a packaging machine according to the invention provided with a side gripper unit as defined by the claims.

The invention can be better understood and implemented with reference to the attached drawings, which illustrate an embodiment thereof by way of non-limiting example.

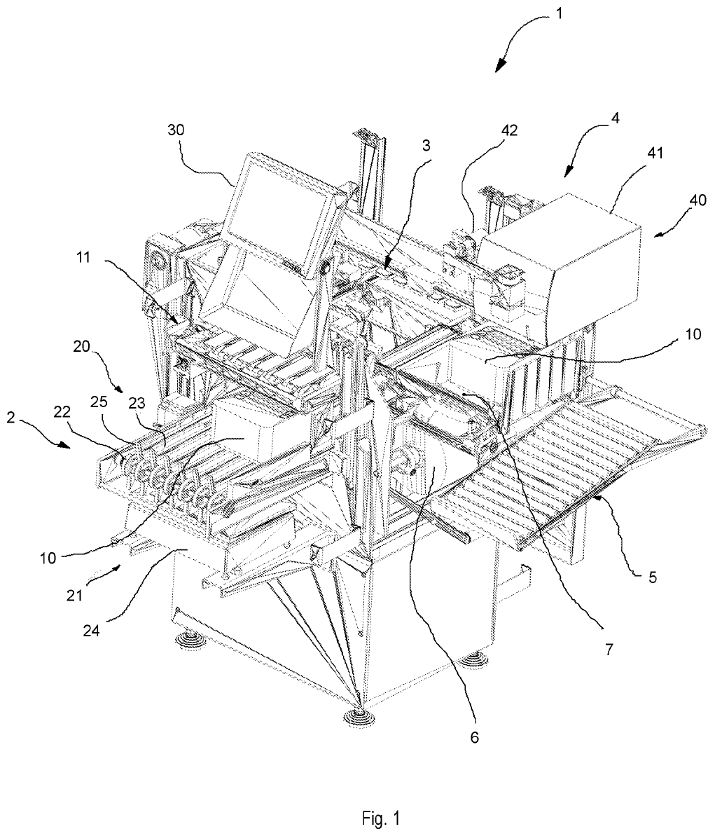

FIG. 1 is a perspective view of a packaging machine devoid of guards;

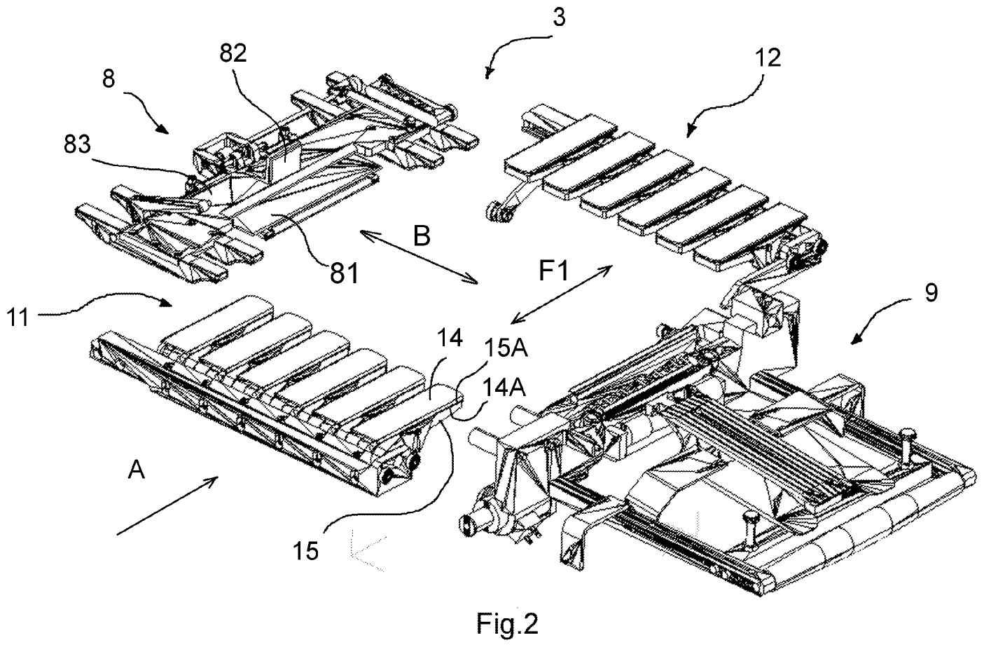

FIG. 2 is a partial top plan view of the packaging machine of FIG. 1 illustrating a rear gripper unit, a distributor unit and two side gripper units;

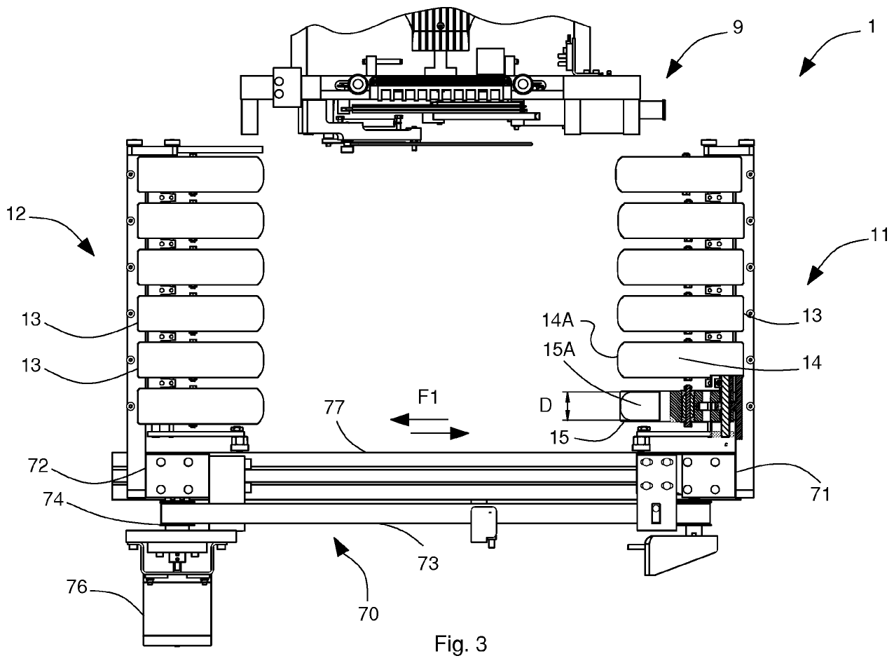

FIG. 3 is a partial perspective view of the distributor unit and of the two side gripper units;

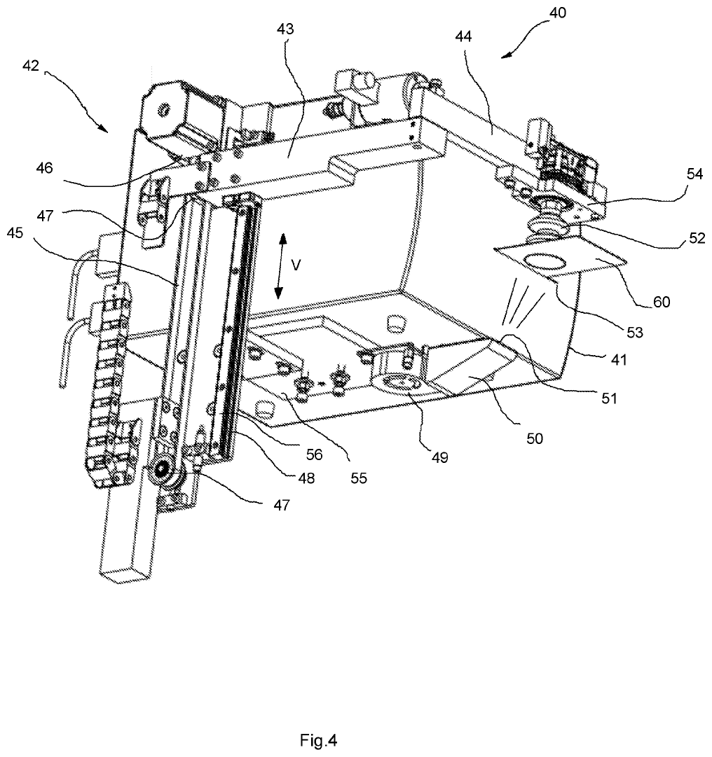

FIG. 4 is a perspective view of a labelling unit provided in the packaging machine of FIG. 1.

FIG. 1 shows a packaging machine 1 for packaging products, for example food products, in particular fresh foods like meat, fish, fruit and vegetables or gourmet products, with an extendible film. The packaging machine 1, illustrated here devoid of guards, is of automatic type, i.e. receives an incoming product to be wrapped, such as for example a fresh food arranged and placed by an operator on a tray made of cardboard or expanded polystyrene or of another similar material, and provides the outgoing product—the fresh food together with the tray—wrapped with the optionally transparent, and already labelled, extendible film. In this manner, by using the packaging machine 1 inside a food shop or a supermarket, the operator can remove the packaged and labelled product from the packaging machine 1 and arrange it on a shelf or in a refrigerator display window to be displayed to customers, with great time saving.

The packaging machine 1 comprises an inlet zone 2, in which the operator arranges the product 10 to be wrapped, for example a fresh food arranged on a tray, an inner or wrapping zone 3, in which the product is wrapped in the extendible film, a labelling zone 4 and an outlet zone 5, in which the packaged and labelled product 10 is received whilst waiting to he removed by the operator.

The outlet zone 5 and the inlet zone 2 are on the same side of the packaging machine 1, for example on the front side of the machine, this enabling a single operator to supply the packaging machine 1 with the products to be packaged and further to access the packaged products, for example to load the packaged products onto a carriage and thus take the packaged products to the section of the shop in which they have to be displayed.

The packaging machine 1 includes different units or groups that perform different tasks but interact with one another, such as for example units or groups disclosed in EP0619227A1.

At the inlet of the packaging machine 1 there is a supplying unit 20 that comprises a weighing device 21 for weighing the product 10 and a conveying device 22 of the belt type for conveying the product 10 along a supplying direction A. Resting element 23 are interposed between the belt of h conveying device 22 and define a supporting plane for the product 10 in the inlet zone 2 of the machine 1. The resting elements 23 are connected directly to a scale 24 of the weighing device 21 located below the belts of the conveying device 22 to detect the weight of the product 10. The belts are provided with carriers 25 that are aligned between themselves that, during advancement of the upper branch of the belts, push the product 10, resting slidingly on the resting elements 23, from the inlet zone 2 to the central zone 3, to the centre of the packaging machine 1. Further, the carriers 25, during the advancement of the product 10 along the supplying direction A, induce the product 10 to be arranged parallel to the carriers, with one side parallel to a thrust surface defined by the carriers 25. In other words, the carriers 25 enable the tray of the product 10 to be straightened so that it has a suitable packaging position. This is very convenient for the operator, who does not have to pay particular attention to how to position the product 10 on the conveying device 22, as the product can be arranged in the inlet zone 2 according to any orientation.

The inlet zone 2 is further provided with laser sensors, which are not shown, which detect the length, width and height of the product 10 and transmit these data to a computer of the packaging machine 1 that adjusts the affected units on the basis of the detected dimensions.

The belts of the conveying device 22 convey the product 10, which is weighed by the weighing device 21 and measured by the sensors, as far as a lifter of known type, which is accordingly not shown and is not disclosed in detail, provided inside the packaging machine 1. The lifter performs the function of lifting the product 10 from the belt height to a packaging height. The lifter comprises a plurality of brackets that are inserted partially between one belt and the other of the conveying device 22 in an end zone of the latter. For example, the lifter can comprise four brackets. One or two brackets further from the outlet zone 5 can be neutralized to prevent the one or two brackets interfering with other parts of the packaging machine 1 on the basis of the dimensions of the tray to be packaged, when the tray to be packaged has a length that is less than the maximum length that is packagable by the machine 1.

On each bracket, a plurality of lowerable supports is fitted, which are generally vertical and distributed along a row, having a convex upper surface for support with the product 10 and which are initially arranged below the ideal plane that contains the upper branch of the belts of the conveying device 22, so as not to interfere with the arriving product 10. More than one row of lowerable supports can also be fitted on a bracket.

The lifter is driven vertically by an electric motor by a belt and pulley transmission, a sliding block fixed to a linear guide being connected to the belt. Unlike a screw and nut drive driven by a motor that is generally used for the lifter of packaging machines of known type, like for example the packaging machine disclosed in EP0619227A1, this type of drive enables the desired lifting speed to be obtained with lower installed power and moreover reduces lifter noise.

Whilst the lifter takes the tray to the packaging height, the extendible film is in the meantime extended in the inner zone 3 between a distributing unit 9 and a rear gripper unit 8. Thus, when the tray reaches the raised position, an upper surface of the product 10 meets the extendible film that is already ready for wrapping.

The distributing unit 9 is arranged for dispensing a portion of the continuous extendible film and the rear gripper unit 8 is arranged for cooperating with the distributing unit 9 to extend the portion of the extendible film along an operating direction B in the wrapping zone 3 inside the packaging machine 1.

In this zone, in addition to the rear gripper unit 8 and the distributing unit 9, there are also two side gripper units 11 and 12. Each of the side gripper units 11 and 12 comprises a plurality of grippers 13 that are the same as one another, placed alongside one another, in particular six grippers. Each gripper 13 comprises an upper jaw 14 and a lower jaw 15. When the distributing unit 9 extends the film in the inner zone 3, side flaps of the film are inserted between the lower jaws 15 and upper jaws 14, the side grippers 13 being in an open position that is not shown. The side gripper units 11 and 12 grasp the film laterally, with the grippers 13 that move to a closed configuration shown in FIG. 3, and arrange the respective side flaps of the film grasped by the grippers 13 below the product 10 to be wrapped, the product 10 being raised to the highest wrapping height of the upper surface of the side grippers.

To do this, the side gripper units 11 and 12 are movable reciprocally towards and away from one another along a direction F1 that is transverse to the operating direction B. Each gripper unit 11 and 12 is provided with a respective carriage 71, 72 that is movable along the same guide 77 and fixed to a branch of the same belt 73, with a transmission system 70 in which the belt 73 winds two pulleys 74 and 75, the drive pulley 74 of which is driven by a motor 76 provided with an inverter, controlled by the computer of the packaging machine 1. In particular, the gripper unit 11, shown on the right in FIG. 3, is fitted to the upper branch of the belt 73 and the gripper unit 12, arranged on the left in FIG. 3, is fitted to the lower branch of the same belt 73 at a distance from the gripper unit 11 that is equal to half the reciprocal advancement or retraction stroke. With the same movement of the belt 73 in one of the two directions F1 it is thus possible to achieve a synchronous movement of the two gripper units 11 and 12

The drive system of the side gripper units 11 and 12 is as effective as but simpler and cheaper than driving of the side gripper units achieved by two movable mechanisms inside a single guide body, guided by corresponding feed screws guided by corresponding motors provided in EP0619227A1, this contributing to making the packaging machine 1 relatively easier to build and maintain.

Each upper jaw 14 and lower jaw 15 is provided with a respective contact surface 14A and 15A arranged for interacting with the extendible film retained by the gripper 13. At least one of the contact surfaces 14A and 15A has a width D that is greater than 50 mm measured along the operating direction B.

By adapting the width D of the upper contact surface to 50 mm, it is possible to ensure a sufficiently wide contact area and a good load distribution of lateral pull on the extendible film, limiting the concentration of force that could cause undesired local deformation of the extendible film, which could cause wrinkles on the produced package or initial tear points of the extendible film.

In particular, the width of at least one of the two contact surfaces 14A and 15A is comprised between 51 mm and 60 mm, and still more in particular, it measures 57 mm. With this measurement of the width of the single side gripper, with the same maximum dimension of the tray that can be packaged it is possible to provide a smaller number of side grippers than seven, namely six, this reducing the number of components of the machine 1 with respect to known machines, thus providing a significant advantage in terms of production time and cost of the machine.

For example, the contact surface that has this width is arranged in the lower jaw 15. in this manner it is possible to produce an upper jaw with lesser width than the lower jaw, this facilitating the separation of the extendible film from the side grippers, once the film has been folded below the product, whilst maintaining an ample contact surface between the grippers and extendible film that is necessary for lateral pulling and correct folding. In this manner it is possible to limit the risk that the extendible film remains sticking to the side grippers when the rear gripper unit advances to the distributing unit to refold the rear flap of the film and push the product to the outlet zone 3. For example, in one embodiment, if the contact surface on the lower jaw is 57 mm wide, the contact surface on the upper jaw can be 45 mm wide,

The dimension of the side gripper 13 that is greater than 50 mm enables the need to increase the range of tray dimensions that can be packaged with a packaging machine of known type, like that disclosed in EP0619227A1, to be coupled with the need to maintain the control of the lateral pull of the extendible film without generating undesired local excessive tensile stress.

In fact, owing to the dimension of the contact surface, by driving even just two adjacent side grippers 13 to grasp the film laterally, it is possible to wrap the extendible film around trays measuring in—length×width×height—100 mm×100 mm×10 mm or also 80 mm×80 mm×10 min. This increases significantly the range of dimensions of products that are packagable by the packaging machine 1, thus being able to meet the need to package reduced portions.

One packaging method that is actuatable by the packaging machine 1 thus provides the steps of dispensing a portion of the continuous extendible film and extending the portion of the extendible film along the operating direction B in the wrapping zone 3 inside the packaging machine 1 and further comprises the step of grasping the extendible film laterally and arranging the film below the product 10 to be wrapped, in which grasping laterally comprises tightening the film between only two side grippers that are adjacent for each side.

Owing to this method, it is possible to package trays having a larger range of dimensions that is more extended towards the smaller dimensions.

The rear gripper unit 8 comprises a rear gripper that is not visible in FIG. 3, arranged below a plate defining a rear folder 81. The rear gripper unit 8 is movable along the operating direction B, which is transverse to the supplying direction A of the packaging machine 1. When the movable rear gripper is in the advanced position, it grasps a head end of the extendible film exiting the distributing unit 9, and, retracting, extends the extendible film in the inner zone 3 through the side grippers 13 in an open position; the extendible film is unwound from a reel 6 (FIG. 1) fitted to the packaging machine 1. The rear folder 81 folds the film below the product 10 during advancement of the rear gripper to the distributing unit 9 whilst a pusher 82 pushes the product 10 to the labelling zone 4.

The rear gripper unit 8 comprises a carriage 83 driven by a motor and controlled by the computer of the machine by a system with belt and pulleys that is not shown. Also this drive contributes to making the machine simpler and easy to maintain.

When the product 10 reaches the vicinity of the distributing unit 9 a cutting device of known type cuts the film, the front flap of which is folded below the product 10 during advancement of the product 10 by a front folder, which is also of known type.

The product 10 thus reaches a heating plane 7 that fixes the flaps of the film folded therebelow. A labelling unit 40 is present here that applies a label 60, for example an adhesive label, to the product 10 with predefined information and/or information that can be selected by an operator via a screen 30 interfacing with the computer.

The label 60 is applied automatically when a presence sensor detects the presence of the product 10 packaged in a preset position.

The labelling unit 40 comprises a labeller 41 of known device and an applicator device 42 that removes the label 60 exiting the labeller 41 and applies the label 60 to the product 10 below.

The applicator device 42 comprises a first arm 44, that is substantially horizontal and parallel to one side of the labeller 41 that includes an outlet port 53 from which the label 60 printed by the labeller 41 exits.

The first arm 44 is provided with a head plate 54 that supports an applicator pad 52, for example of deformable type to adapt to the conformation of the surface of the product; the pad 52 is located above the outlet port 53.

The deformable pad 52 can be provided with a sucking element fitted to the head plate 54 to capture the label by sucking.

The first arm 44 is supported by a second arm 43, which is also substantially horizontal and parallel to a second side of the labeller 41 which is substantially orthogonal to the first side.

The applicator device 42 further comprises a substantially vertical third arm 48, that supports and connects the second arm 43 to a frame of the packaging machine 1. A support plate 55 for supporting the labeller 41 is further fixed to the third arm 48. The third arm 48 further supports a movement device for moving the applicator device 42 to move the second arm 43 and the first arm 44 according to an application direction V, downwards and/or upwards between a top rest position and an application position in contact with the product 10. The movement device comprises a pair of pulleys 47 on which a belt 45 is wound that is driven by a motor 46. The second arm 43 is connected to the belt 45 and moves along a guide orthogonally to the belt 45, the guide 56 being fitted parallel to and onto the third arm 48.

The support plate 55 further supports a fan 49 the delivery of which is connected to an outlet conduit 50 of tapered form so that the thus formed fan circuit can create an air blade below the outlet port 53 of the labeller 41. This air blade is able to support the label 60 for the fraction of time necessary for the deformable pad 52 to reach the label 60.

When the packaged product 10 is positioned below the outlet port 53, the deformable pad 52 captures and presses the label 60 against the surface of the product 10. The second arm 43 and the first arm 44 are driven downwards by a height that is calculated on the basis of the height of the product detected in the inlet zone 2.

Owing to the labelling unit 40, the product 10 exits the packaging machine 1 already provided with a label with the packaging information and other information that can be selected by an operator. After reaching the outlet zone, the product 10 is ready to be positioned on the shop shelf.

The applicator device 42 can be applied to any type of labeller having a substantially horizontal outlet port. In one embodiment that is not shown, the length of the first arm 44 and the second arm 43 is adjustable so as to be able to adapt to different types of labeller having sides of different dimensions.

1. A product packaging machine for packaging products with extendible film provided with a labelling unit for the automatic application of a label to a packaged product comprising a labeller and a label applying device, wherein the label applying device comprises a first arm that is substantially horizontal and parallel to a first side of said labeller on which an outlet port of said label is positioned for the exit of said label from said labeller, an applicator pad fitted to said first arm, a second arm that is substantially horizontal and parallel to a second side of said labeller for supporting said first arm, said first arm and said second arm being movable vertically to remove said label from said outlet port and apply the label from above to said product.

2. The product packaging machine according to claim 1, in which the stroke of said first arm and said second arm is variable on the basis of the height of said product, said height being detected in an inlet zone of said packaging machine.

3. The product packaging machine according to claim 1, wherein said applicator pad is deformable to adapt to the conformation of the surface of the product during the pressing action thereof on the surface of the product.

4. The product packaging machine according to claim 1, wherein said labelling unit comprises a fan circuit to create an air blade below said outlet port for supporting said label exiting said outlet port.

5. The product packaging machine according to claim 1, wherein said applicator pad is provided with a sucking element fitted to the head plate for capturing said label by sucking.

6. The product packaging machine according to claim 1, wherein the length of said first arm and said second arm is adjustable to the dimensions of said labeller.

7. A label applying device for applying a label to a product and which is associable to a labeller, said label exiting a labeller, comprising a first arm that is substantially horizontal and parallel to a first side of said labeller on which an outlet port of said label positioned for the exit of said label from said labeller, an applicator pad fitted to said first arm, a second arm that is substantially horizontal and parallel to a second side of said labeller for supporting said first arm, wherein said first arm and said second arm are movable vertically to remove said label from said outlet port and apply said label from above to said product.

8. The label applying device according to claim 7, in which the stroke of said first arm and said second arm is variable on the basis of the measured height of said product.

9. The label applying device according to claim 7, wherein said applicator pad is deformable to adapt to the conformation of the surface of the product during the pressing action thereof on the surface of the product.

10. The label applying device according to claim 7, and further comprising a frame for supporting a fan circuit arranged to create an air blade below said outlet port supporting said label exiting said outlet port.

11. The label applying device according to claim 7, wherein said applicator pad is provided with a sucking element fitted to the head plate for capturing said label by sucking.

12. The label applying device according to claim 7, wherein the length of said first arm and said second arm is adjustable to the dimensions of said labeller.

13. A product packaging machine for packaging products with extendible film provided with a labelling unit for the automatic application of a label to a packaged product comprising a labeller and a label applying device, wherein the label applying device comprising:
a first arm that is substantially horizontal and parallel to a first side of said labeller on which an outlet port of said label is positioned for the exit of said label from said labeller;
an applicator pad fitted to said first arm; and
a second arm that is substantially horizontal and parallel to a second side of said labeller for supporting said first arm, wherein
said first arm and said second arm being movable vertically to remove said label from said outlet port and apply the label from above to said product.

14. The product packaging machine according to claim 13, wherein the stroke of said first arm and said second arm is variable on the basis of the height of said product, and
said height being detected in an inlet zone of said packaging machine.

15. The product packaging machine according to claim 13, wherein said applicator pad is deformable to adapt to the conformation of the surface of the product during the pressing action thereof on the surface of the product.

16. The product packaging machine according to claim 13, wherein said labelling unit comprises a fan circuit to create an air blade below said outlet port for supporting said label exiting said outlet port.

17. The product packaging machine according to claim 13, wherein said applicator pad is provided with a sucking element fitted to the head plate for capturing said label by sucking.

18. The product packaging machine according to claim 13, wherein the length of said first arm and said second arm is adjustable to the dimensions of said labeller.
